(19) United States
(12) Patent Application Publication
(10) Pub. No.: US 2017/0300317 A1
(43) Pub. Date: Oct. 19, 2017

(54) SYSTEM AND METHOD FOR PATCHING SOFTWARE IN A TARGET COMPUTER SYSTEM DEVICE

(71) Applicant: Knight Point Systems, Inc., Reston, VA (US)

(72) Inventors: Roy Keene, Reston, VA (US); Kenneth Van Alstyne, JR., Reston, VA (US)

(73) Assignee: Knight Point Systems, Inc., Reston, VA (US)

(21) Appl. No.: 15/461,605

(22) Filed: Mar. 17, 2017

Related U.S. Application Data
(60) Provisional application No. 62/312,522, filed on Mar. 24, 2016.

(51) Int. Cl. G06F 9/445; G06F 21/44; G06F 17/30; G06F 21/57; G06F 9/44

(52) U.S. Cl. CPC G06F 8/67; G06F 21/575; G06F 9/4406; G06F 17/30109; G06F 21/44

(57) ABSTRACT

A system and method for patching software in a target computer system device, the system comprising at least one memory device to store a set of program modules. At least one processor executes the set of program modules comprising an input module, a data transfer module, and a patching module. The input module receives from a user, an instruction to copy at least one patch bundle into the at least one memory device. The data transfer module, is configured to extract at least one of the hot patch scripts, the hot patch index, and the boot file scripts from the at least one patch bundle. The patching module, implements the hot patch scripts and the boot file scripts on the target computer system device, and records information regarding implementation of the hot patch scripts and the boot file scripts. The information is recorded in the hot patch index.

### CROSS REFERENCE TO APPLICATION

This patent application claims the benefit of U.S. Provisional Application No. 62/312,522 filed on Mar. 24, 2016. The above application is incorporated by reference herein in its entirety.

### FIELD OF THE INVENTION

The present invention relates generally to a system and method for the automated patching of operating systems from a non-persistent storage, and, more particularly, to a system and method that allows for the automated patching of system/network updates from a patch server to various nodes of that system/network on the basis of patch indexes kept by each of the various nodes.

### BACKGROUND OF THE INVENTION

Standard operating system (OS) patching is based on the OS having persistent storage—i.e. storage existing past shutdown/restart of the OS. This is what allows the system to know which patches have already been applied upon startup of the system. In a cluster where compute nodes have non-persistent storage, any patching would have to be completed from scratch every time. Since many patches require rebooting of the machine, a loop occurs in which: a patch requires reboot, which then de-provisions the node; upon re-startup, the node starts applying patches and restarts per the patch requirements again resulting in de-provisioning.

Hence, there is a need for a system and method of patching software in a target computer system device with non-persistent storage.

### SUMMARY OF THE INVENTION

The present invention relates to a system and method for patching a target computer system device.

In one embodiment of the present invention, a system for patching software in a target computer system device, comprises a cluster of computer system devices comprising at least one target computer system device. Further, the system comprises one or more memory devices, comprised in one or more computer system devices of the cluster of computer system devices. At least one memory device among the one or more memory devices stores a set of program modules. The one or more memory devices comprises a designated data staging area. The system further comprises a plurality of processors, each processor being comprised in each computer system device of the cluster of computer system devices. At least one processor executes the set of program modules. The set of program modules comprises an input module, a data transfer module, and a patching module. The input module, executed by the at least one processor, is configured to receive from a user, an instruction to copy at least one patch bundle into the at least one memory device, wherein the at least one patch bundle comprises boot file scripts, hot patch scripts, a hot patch index, and conditions for implementation of the hot patch scripts, and the boot file scripts. The data transfer module, executed by the at least one processor, is configured to extract at least one of the hot patch scripts, the hot patch index, and the boot file scripts from the at least one patch bundle, copy at least one of the hot patch scripts, the hot patch index and the boot file scripts into the designated data staging area, there by staging the at least one of hot patch scripts and boot file scripts, and append the conditions for implementation of the hot patch scripts and the boot file scripts into at least one staging index in the designated data staging area. The patching module, executed by the at least one processor, is configured to implement the hot patch scripts and the boot file scripts on the target computer system device, and record information regarding implementation of the hot patch scripts and the boot file scripts, wherein the information is recorded in the hot patch index.

In one embodiment of the present invention, the at least one memory device further comprises a plurality of trusted patch signatures and patch certificates. Further, the at least one patch bundle further comprises at least one patch certificate, at least one patch signatures, information associated with applicability of the boot file scripts. The system further comprises an authentication module, executed by the at least one processor, configured to extract the at least one patch signature and the at least one patch certificate from the at least one patch bundle. Further, the authentication module is configured to compare the at least one patch signature and at least one patch certificate with each of the plurality of trusted patch signatures and patch certificates, and to authenticate the at least one patch signature and at least one patch certificate based on the at least one patch signature and at least one patch certificate being identical to (signed by) at least one of the plurality of trusted patch signatures and patch certificates. The system further comprises a patch monitor module, executed by the at least one processor, configured to download at least one hot patch index from the patch server (not shown) at predefined intervals of time, identify a set of applicable patches in the patch server (not shown), and notify the user about the set of applicable patches. Each computer system device in the cluster of computer system device is at least one of a laptop, a server, a local area network, a personal computer, and a smart phone, or any combination thereof. The cluster of computer system devices use one of Trivial File Transfer Protocol (TFTP), and Dynamic Host Configuration Protocol (DHCP). The at least one memory device and the plurality of processors host a Pre-Boot Execution Environment. The system further comprises a scanning module, configured to scan the at least one patch bundle for hot patch scripts and boot file scripts. Further the patching module builds a patch boot archive.

In one embodiment of the present invention, a method of patching software in a target computer system device comprises storing in at least one memory device, comprised in one or more computer system devices of the cluster of computer system devices, a set of program modules. Further, the method comprises receiving by at least one processor, via an input module, an instruction to copy at least one patch bundle into the at least one memory device, wherein the at least one patch bundle comprises boot file scripts, hot patch scripts, a hot patch index, and conditions for implementation of the hot patch scripts, and the boot file scripts. Further, the method comprises extracting by the at least one processor via a data transfer module, at least one of the hot patch scripts, the hot patch index, and the boot file scripts from the at least one patch bundle from a patch server. Further, the method comprises copying by the at least one processor via the data transfer module, at least one of the hot patch scripts, the hot patch index and the boot file scripts into the designated data staging area, there by staging the at least one of hot patch scripts and boot file scripts. Further, the method comprises appending by the at least one processor via the data transfer module, the conditions for implementation of the hot patch scripts and the boot file scripts into at least one staging index. Further, the method comprises implementing by the at least one processor via a patching module, the hot patch scripts and the boot file scripts on the target computer system device. Further, the method comprises recording by the at least one processor, via the patching module, information regarding of implementation of the hot patch scripts and the boot file scripts, wherein the information is recorded in the hot patch index.

### BRIEF DESCRIPTION OF DRAWINGS

FIG. 1 is a block diagram of an environment implemented in accordance with various embodiments of the present invention.

FIG. 2 is a block diagram of a system for patching software in a target computer system device in accordance with various embodiments of the present invention.

FIG. 3 is a flowchart of a computer implemented method of patching software in a target computer system device in accordance with various embodiments of the present invention.

FIG. 4 is a flowchart of a computer implemented method of applying a patch in accordance with various embodiments of the present invention.

### DETAILED DESCRIPTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

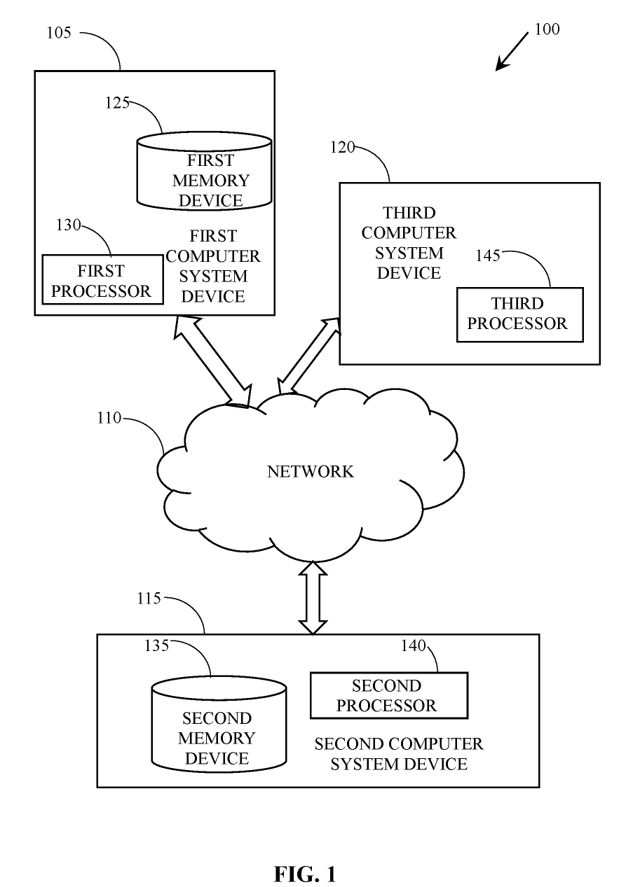

FIG. 1 is a block diagram of an environment 100 in accordance with which various embodiments of the present invention are implemented. The environment 100 comprises a first computer system device 105, a second computer system device 115, and a third computer system device 120. In one example, the first computer system device 105, the second computer system device 115, and the third computer system device 120 are connected as a computer cluster. In one example, the computer cluster use one of Trivial File Transfer Protocol (TFTP), and Dynamic Host Configuration Protocol (DHCP) to communicate with each other. The cluster of computers is enabled to host a floating Pre-boot Execution Environment. The first computer system device 105, the second computer system device 115, and the third computer system device 120 are at least one of a laptop, a personal computer, a server, a smart phone, and a smart television. In another example, the first computer system device 105, the second computer system device 115, and the third computer system device 120 are gateways to at least one of a wide area network, a local area network, and internet. The first computer system device 105, the second computer system device 115, and the third computer system device 120 are connected via a network 110. The network 110 is at least one of a mobile network, a wide area network, a local area network, and internet. The first computer system device 105 comprises a first memory device 125 and a first processor 130. The second computer system device 115 comprises a second memory device 135, and the second processor 140. The third computer system device 120 comprises the third processor 145. In one embodiment of the present invention, the computer cluster comprising the first computer system device 105, the second computer system device 115, and the third computer system device 120 hosts a system for patching software in a target computer system device. In one example, the target computer system device is at least one of the first computer system device 105, the second computer system device 115, and the third computer system device 120.

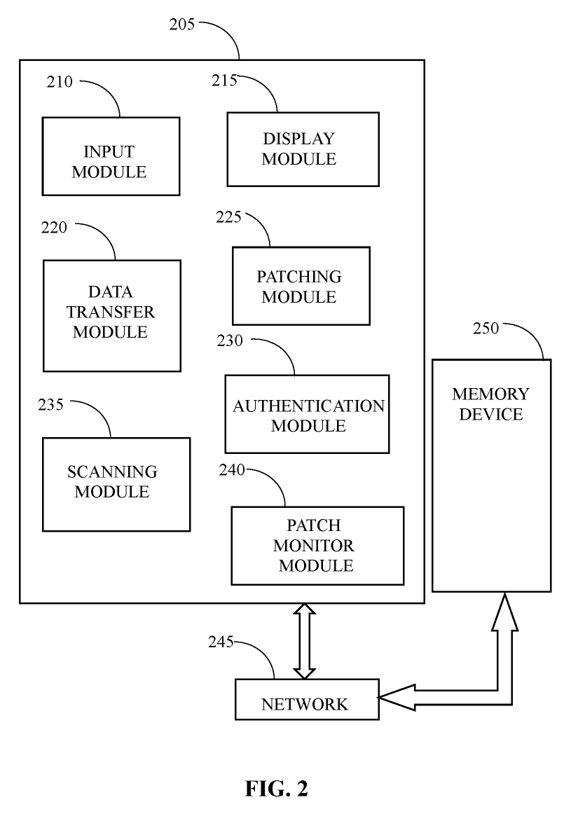

At least one of the first memory device 125 and the second memory device 135 is a designated data staging area. Further, at least one of the first memory device 125 and the second memory device 135 stores a set of program modules. The set of program modules comprises an input module (not shown), a data transfer module (not shown), a patching module (not shown), an authentication module (not shown), a patch monitor module (not shown), and a scanning module (not shown). At least one processor among the first processor 130, the second processor 140, and the third processor 145 executes the set of program modules. The at least one processor executes the set of program modules to apply one of a system patch and a network patch on the at least one target computer system device. In one example, the set of program modules are executed by a combination of multiple processors among the first processor 130, the second processor 140, and the third processor 145. FIG. 2 is a block diagram of a system for patching software in a target computer system device according to one example of functioning of the present invention.

Referring to FIG. 2, in one example, a memory device 250 stores a set of program modules comprising an input module 210, a display module 215, a data transfer module 220, a patching module 225, an authentication module 230, a patch monitor module 240, and a scanning module 235. The memory device 250 further comprises a plurality of trusted patch signatures and patch certificates. A processor 205 executes the set of program modules. In one example, the processor 205 communicates with the memory device 250 via a network 245. The processor 205 executes the input module 210, to receive from a user, an instruction to copy at least one patch bundle from a patch server (not shown), into the memory device 250. The at least one patch bundle comprises boot file scripts, hot patch scripts, a hot patch index, information regarding applicability of the hot patch scripts, information regarding applicability of the boot file scripts, and conditions for implementation of the hot patch scripts, and the boot file scripts. In another example, the patch bundle comprises at least one patch certificate, at least one patch signature, information associated with applicability of the hot patch scripts and the boot file scripts. The processor 205 executes the data transfer module 220, to extract at least one of the hot patch scripts, the hot patch index, and the boot file scripts from the at least one patch bundle.

Further, the processor 205 executes the data transfer module 220 to copy at least one of the hot patch scripts, the hot patch index and the boot file scripts into a designated data staging area (not shown), thereby staging the at least one of hot patch scripts and boot file scripts.

Further, the processor 205 executes the data transfer module 220 to append the conditions for implementation of the hot patch scripts and the boot file scripts into at least one staging index in the designated data staging area. Furthermore, the processor 205 executes the patching module 225 to implement the hot patch scripts and the boot file scripts on the at least one target computer system device. Furthermore, the processor 205 executes the patching module 225 to record information regarding implementation of the hot patch scripts and the boot file scripts. The information is recorded in the hot patch index.

Furthermore, the processor 205 executes the authentication module 230, to extract the at least one patch signature and the at least one patch certificate from the at least one patch bundle. Moreover, the authentication module 230 compares the at least one patch signature and at least one patch certificate with each of the plurality of trusted patch signatures and patch certificates. The authentication module 230 authenticates the at least one patch signature and at least one patch certificate based on the at least one patch signature and at least one patch certificate being identical to (signed by) at least one of the plurality of trusted patch signatures and patch certificates. The processor 205 executes the patch monitor module 240, to download at least one hot patch index from the patch server (not shown) at predefined intervals of time, identify a set of applicable patches in the patch server (not shown), and notify the user about the set of applicable patches. In one example, the predefined interval of time is 10 minutes.

In one example, the memory device 250 and the processor 205 hosts a floating Pre-Boot Execution Environment. The processor 205 executes the scanning module 235, to scan the at least one patch bundle for hot patch scripts and boot file scripts. Furthermore, the patching module 225 builds a patch boot archive.

In an exemplary illustration of the working of the present invention, the system for patching software in the target computer system device supports both hot patches as well as boot file script. If a software publisher newly releases a hot patch script, then the display module 215 present a user with a notification about the newly released hot patch script. The input module 210 enables the user to copy the hot patch script into the memory device 250. In one example, the memory device 250 is a storage node and hosts one of a Pre-Boot Execution Environment and a Trivial File Transfer Protocol (TFTP) server. In one example, the Pre-Boot Execution Environment (PXE) is a floating PXE. Further, at least one memory device in the computer cluster is a designated data staging area, comprising a staging index.

By copying the hot patch script into the memory device 250, the processor 205 effectively copies the hot patch script into the storage node hosting the Pre-Boot Execution Environment (PXE)/TFTP server. In one example, the Pre-Boot Execution Environment (PXE)/TFTP server is a floating PXE/TFTP server. Further, the user instructs the processor 205 to import a patch bundle from a patch server (not shown). The processor 205 verifies a patch signature of the patch bundle, and authenticates a patch certificate of the patch bundle.

The patch bundle comprises a hot patch index. The processor 205 copies the hot patch index to the staging index. Further, the processor 205 scans the patch bundle for hot patch scripts and boot file scripts. The processor 205 extracts at least one of the boot file scripts and the hot patch scripts. Further, the processor 205 copies the at least one of the boot file scripts and the hot patch scripts into the designated data staging area. Further, it is noted that the patch bundle comprises at least one hot patch ID, conditions for implementation of the hot patch scripts and information regarding applicability of the hot patch scripts in the target computer system device.

The processor 205 appends the hot patch ID and conditions for implementing the hot patch scripts to the staging index. The processor 205 relocates the hot patch index, the boot file scripts, and the hot patch scripts, after to production, after staging process. Next, the processor 205 builds the patch boot archive. Furthermore, the processor 205 applies the hot patch script in the target computer system device in accordance with the information regarding the applicability of the hot patch script.

In another example, the processor 205 downloads a hot patch index via a Trivial File Transfer Protocol (TFTP) boot server. The processor 205 extracts a plurality of hot patch scripts and hot patch IDs from the patch server (not shown). The processor 205 retrieves a hot patch ID of a first hot patch script from the hot patch index. As mentioned above, the hot patch index and the patch bundle has information regarding applicability of the first hot patch script in the target computer system device. The processor 205 extracts information with regards to whether the hot patch script has already been applied to the target computer system device. If the first hot patch script has not been applied on to the target computer system device, then the processor 205 checks whether the first hot patch script is applicable. If the hot patch script is applicable, then the processor 205 downloads the hot patch script from one of a boot server and the patch server (not shown).

In one example, the processor 205 determines whether the hot patch script download has been successful. If download of the hot patch script is successful, then the processor 205 executes the hot patch script. Further, the processor 205 determines whether if execution of the hot patch script is successful. If the execution is successful, then the hot patch script is marked as applied in the hot patch index. Further, the processor 205 marks a SUCCESS indicator in the hot patch index. If the execution of the hot patch script is not successful, then the processor 205 marks the hot patch script as a FAILURE in the hot patch index.

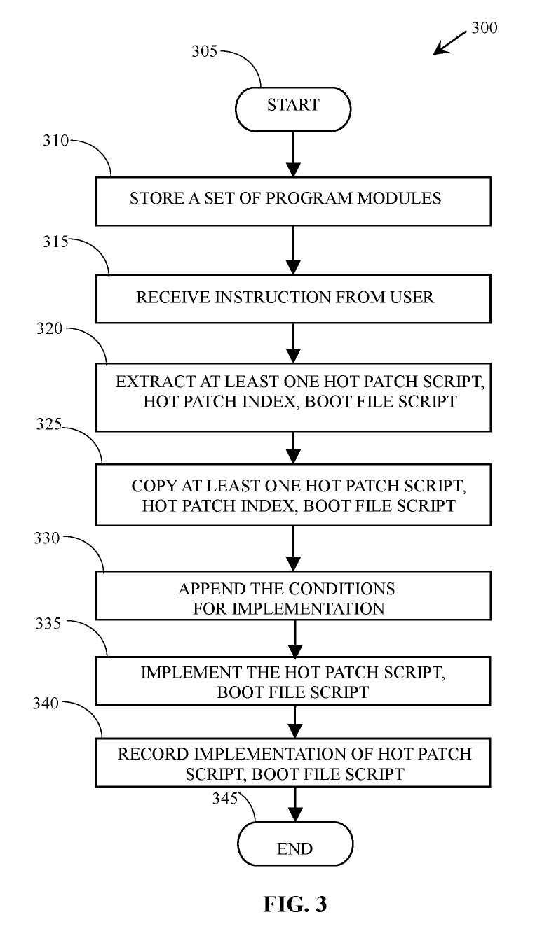

FIG. 3 is a flowchart of a computer implemented method of patching software in a target computer system device in accordance with various embodiments of the invention. The method is incorporated in an environment comprising a first computer system device, a second computer system device, and a third computer system device. In one example, the first computer system device, the second computer system device, and the third computer are connected as a computer cluster. In one example, the computer cluster use one of Trivial File Transfer Protocol (TFTP), and Dynamic Host Configuration Protocol (DHCP) to communicate with each other. The cluster of computers is enabled to host a floating Pre-boot Execution Environment.

The first computer system device, the second computer system device, and the third computer system device are at least one of a laptop, a personal computer, a server, a smart phone, and a smart television. In another example, the first computer system device, the second computer system device, and the third computer system device are gateways to at least one of a wide area network, a local area network, and internet. The first computer system device, the second computer system device, and the third computer system device are connected via a network. The network is at least one of a mobile network, a wide area network, a local area network, and internet. The first computer system device comprises a first memory device and a first processor. The second computer system device comprises a second memory device, and the second processor. The third computer system device comprises the third processor. In one embodiment of the present invention, the computer cluster comprising the first computer system device, the second computer system device, and the third computer system device hosts a system for patching software in a target computer system device. In one example, the target computer system device is at least one of the first computer system device, the second computer system device, and the third computer system device.

At least one of the first memory device and the second memory device is a designated data staging area. Further, at least one of the first memory device and the second memory device stores a set of program modules. The set of program modules comprises an input module, a data transfer module, a patching module, an authentication module, a patch monitor module, and a scanning module. At least one processor among the first processor, the second processor, and the third processor executes the set of program modules. The at least one processor executes the set of program modules to apply one of a system patch and a network patch on the at least one target computer system device. In one example, the set of program modules are executed by a combination of multiple processors among the first processor, the second processor, and the third processor. The method 300 begins at step 305.

At step 310, at least one memory device stores a set of program modules comprising an input module, a display module, a data transfer module, a patching module, an authentication module, a patch monitor module, and a scanning module. The memory device further comprises a plurality of trusted patch signatures and patch certificates. A processor executes the set of program modules. In one example, the processor communicates with the memory device via a network.

At step 315, the processor executes the input module, to receive from a user, an instruction to copy at least one patch bundle from a patch server, into the memory device. The at least one patch bundle comprises boot file scripts, hot patch scripts, a hot patch index, information regarding applicability of the hot patch scripts, information regarding applicability of the boot file scripts, and conditions for implementation of the hot patch scripts, and the boot file scripts. In another example, the patch bundle comprises at least one patch certificate, at least one patch signature, information associated with applicability of the hot patch scripts and the boot file scripts. Furthermore, the processor executes the authentication module, to extract the at least one patch signature and the at least one patch certificate from the at least one patch bundle. Moreover, the authentication module compares the at least one patch signature and at least one patch certificate with each of the plurality of trusted patch signatures and patch certificates. The authentication module authenticates the at least one patch signature and at least one patch certificate based on the at least one patch signature and at least one patch certificate being identical to (signed by) at least one of the plurality of trusted patch signatures and patch certificates.

At step 320, the processor executes the data transfer module, to extract at least one of the hot patch scripts, the hot patch index, and the boot file scripts from the at least one patch bundle.

At step 325, the processor executes the data transfer module to copy at least one of the hot patch scripts, the hot patch index and the boot file scripts into a designated data staging area, thereby staging the at least one of hot patch scripts and boot file scripts.

At step 330, the processor executes the data transfer module to append the conditions for implementation of the hot patch scripts and the boot file scripts into at least one staging index in the designated data staging area.

At step 335, the processor executes the patching module to implement the hot patch scripts and the boot file scripts on the at least one target computer system device.

At step 340, the processor executes the patching module to record information regarding implementation of the hot patch scripts and the boot file scripts. The information is recorded in the hot patch index. The processor executes the patch monitor module, to download at least one hot patch index from the patch server at predefined intervals of time, identify a set of applicable patches in the patch server, and notify the user about the set of applicable patches. In one example, the predefined interval of time is 10 minutes. In one example, the memory device and the processor hosts a floating Pre-Boot Execution Environment. The processor executes the scanning module, to scan the at least one patch bundle for hot patch scripts and boot file scripts. Furthermore, the patching module builds a patch boot archive.

The method 300 ends at step 345.

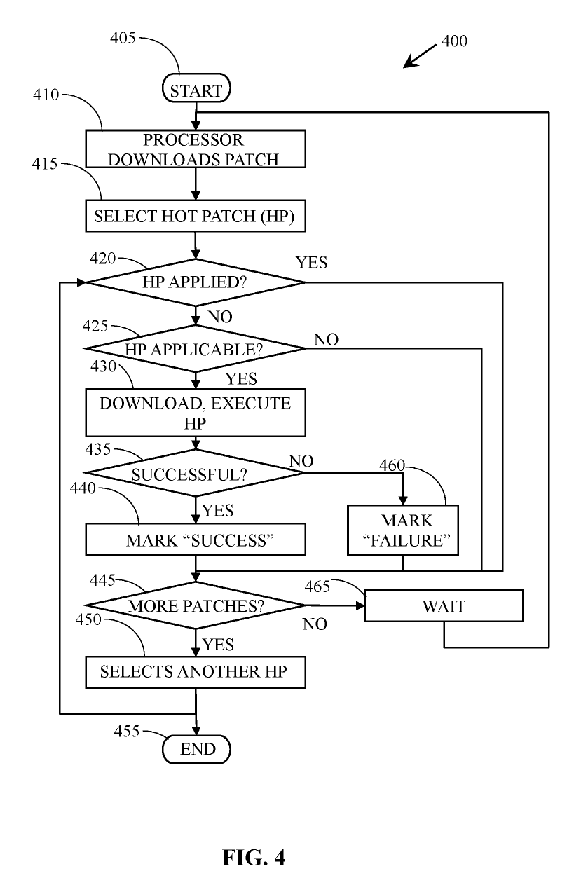

FIG. 4 is a flowchart of a computer implemented method of applying a patch in accordance with various embodiments of the invention. The method 400 begins at step 405.

At step 410, a processor downloads a hot patch index via a Trivial File Transfer Protocol (TFTP) boot server. The processor extracts a plurality of hot patch scripts and hot patch IDs from the patch server (not shown).

At step 415, the processor selects a first hot patch script from the hot patch index based on a hot patch ID. As mentioned above, the hot patch index and the patch bundle has information regarding applicability of the first hot patch script in the target computer system device. The processor extracts information with regards to whether the first hot patch script has already been applied to the target computer system device.

At step 420, the processor determines whether the first hot patch script has been applied on to the target computer system device. If the first hot patch script has been applied, then the processor executes step 445. If the first hot patch script has not been applied, then the processor executes step 425.

At step 425, the processor checks whether the first hot patch script is applicable. If the hot patch script is applicable, then the processor executes step 430. Otherwise, the processor executes step 445.

At step 430, the processor downloads the first hot patch script from one of a boot server and the patch server (not shown). In one example, the processor determines whether download of the hot patch script has been successful. If download of the first hot patch script is successful, then the processor executes the first hot patch script.

At step 435, the processor determines whether download and execution of the hot patch script is successful. If the download and execution is successful, then the processor executes step 440. Otherwise, the processor executes step 460.

At step 440, the processor marks the first hot patch script as applied in the hot patch index. Further, the processor marks a SUCCESS indicator in the hot patch index. After step 440, the processor executes step 445.

At step 460 the processor marks execution of the first hot patch script as a FAILURE in the hot patch index. After step 460, the processor executes step 445.

At step 445, the processor determines presence of more patches in the hot patch index. If the hot patch index has more patches, the processor executes step 450. Otherwise, the processor executes step 465.

At step 465, the processor waits for at least ten minutes and then executes step 410.

At step 450, the processor selects another hot patch script from the hot patch index and the patch bundle and executes step 420.

The method 400 ends at step 455.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for patching software in a target computer system device, the system comprising:
a cluster of computer system devices comprising at least one target computer system device;
one or more memory devices, comprised in one or more computer system devices of the cluster of computer system devices, wherein at least one memory device among the one or more memory devices stores a set of program modules, and wherein the one or more memory devices comprises a designated data staging area;
a plurality of processors, each processor being comprised in each computer system device of the cluster of computer system devices, wherein at least one processor executes the set of program modules, the set of program modules comprising:
an input module, executed by the at least one processor, configured to receive from a user, an instruction to copy at least one patch bundle from a patch server, into the at least one memory device, wherein the at least one patch bundle comprises boot file scripts, hot patch scripts, a hot patch index, and conditions for implementation of the hot patch scripts, and the boot file scripts;
a data transfer module, executed by the at least one processor, configured to
extract at least one of the hot patch scripts, the hot patch index, and the boot file scripts from the at least one patch bundle, and
copy at least one of the hot patch scripts, the hot patch index and the boot file scripts into the designated data staging area, there by staging the at least one of hot patch scripts and boot file scripts, and
append the conditions for implementation of the hot patch scripts and the boot file scripts into at least one staging index in the designated data staging area; and a patching module, executed by the at least one processor, configured to
implement the hot patch scripts and the boot file scripts on the at least one target computer system device, and
record information regarding implementation of the hot patch scripts and the boot file scripts, wherein the information is recorded in the hot patch index.

2. The system of claim 1, wherein the at least one memory device further comprises a plurality of trusted patch signatures and patch certificates.

3. The system of claim 2, wherein the at least one patch bundle further comprises at least one patch certificate, at least one patch signatures, and information associated with applicability of the boot file scripts and the hot patch scripts.

4. The system of claim 3, wherein the system further comprises an authentication module, executed by the at least one processor, configured to:
extract the at least one patch signature and the at least one patch certificate from the at least one patch bundle;
compare the at least one patch signature and at least one patch certificate with each of the plurality of trusted patch signatures and patch certificates; and,
authenticate the at least one patch signature and at least one patch certificate based on the at least one patch signature and at least one patch certificate being identical to at least one of the plurality of trusted patch signatures and patch certificates.

5. The system of claim 1, wherein the system further comprises a patch monitor module, executed by the plurality of processors, configured to:
download at least one hot patch index from the patch server at predefined intervals of time;
identify a set of applicable patches in the patch server; and,
notify the user about the set of applicable patches.

6. The system of claim 1, wherein each computer system device in the cluster of computer system device is at least one of a laptop, a server, a local area network, a personal computer, and a smart phone, or any combination thereof.

7. The system of claim 1, wherein the cluster of computer system devices use one of Trivial File Transfer Protocol (TFTP), and Dynamic Host Configuration Protocol (DHCP) to communicate with each other.

8. The system of claim 1, wherein the at least one memory device and the plurality of processors host a Pre-Boot Execution Environment.

9. The system for claim 1, further comprising a scanning module, configured to scan the at least one patch bundle for hot patch scripts and boot file scripts.

10. The system for claim 1, wherein the patching module builds a patch boot archive.

11. A method of patching software in a target computer system device, the method comprising:
storing in at least one memory device, comprised in one or more computer system devices of a cluster of computer system devices, a set of program modules;
receiving by at least one processor, via an input module, an instruction to copy at least one patch bundle into the at least one memory device, wherein the at least one patch bundle comprises boot file scripts, hot patch scripts, a hot patch index, and conditions for implementation of the hot patch scripts, and the boot file scripts;
extracting by the at least one processor via a data transfer module, at least one of the hot patch scripts, the hot patch index, and the boot file scripts from the at least one patch bundle from a patch server;
copying by the at least one processor via the data transfer module, at least one of the hot patch scripts, the hot patch index and the boot file scripts into the designated data staging area, there by staging the at least one of hot patch scripts and boot file scripts;
appending by the at least one processor via the data transfer module, the conditions for implementation of the hot patch scripts and the boot file scripts into at least one staging index;
implementing by the at least one processor via a patching module, the hot patch scripts and the boot file scripts on the target computer system device; and
recording by the at least one processor, via the patching module, information regarding of implementation of the hot patch scripts and the boot file scripts, wherein the information is recorded in the hot patch index.

12. The method of claim 11, wherein the at least one memory device further comprises a plurality of trusted patch signatures and patch certificates.

13. The method of claim 12, wherein the at least one patch bundle further comprises at least one patch certificate, at least one patch signatures, and information associated with applicability of the boot file scripts and the hot patch scripts.

14. The method of claim 13, further comprising the steps of:
extracting by the at least one processor via an authentication module, the at least one patch signature and the at least one patch certificate from the at least one patch bundle;
comparing by the at least one processor via the authentication module, the at least one patch signature and at least one patch certificate with each of the plurality of trusted patch signatures and patch certificates; and,
authenticating by the at least one processor via the authentication module, the at least one patch signature and at least one patch certificate based on the at least one patch signature and at least one patch certificate being identical to at least one of the plurality of trusted patch signatures and patch certificates.

15. The method of claim 11, wherein the method further comprises the steps of:
downloading, by a plurality of processors via a patch monitor module, at least one hot patch index from the patch server at predefined intervals of time;
identifying by the plurality of processors, via the patch monitor module, a set of applicable patches in the patch server; and,
notifying by a plurality of processors, via the patch monitor module, the user about the set of applicable patches.

16. The method of claim 11, wherein each computer system device in the cluster of computer system device is at least one of a laptop, a server, a local area network, a personal computer, and a smart phone, or any combination thereof.

17. The method of claim 11, wherein the cluster of computer system devices use one of Trivial File Transfer Protocol (TFTP), and Dynamic Host Configuration Protocol (DHCP) to communicate with each other.

18. The method of claim 11, wherein the at least one memory device and the plurality of processors host a Pre-boot Execution Environment.

19. The method for claim 11, further comprising scanning the at least one patch bundle for hot patch scripts and boot files.

20. The method for claim 11, wherein the patching module builds a patch boot archive.
